(19) United States
(12) Patent Application Publication
(10) Pub. No.: US 2024/0125396 A1
(43) Pub. Date: Apr. 18, 2024

(54) VALVE SECTION AND HYDRAULIC SYSTEM WITH A VALVE SECTION

(71) Applicant: HAWE Hydraulik SE, Aschheim (DE)

(72) Inventors: Thomas WECHSEL, Aschheim (DE); Martin HEUSSER, Aschheim (DE)

(21) Appl. No.: 18/488,218

(22) Filed: Oct. 17, 2023

(30) Foreign Application Priority Data
Oct. 17, 2022 (DE) 10 2022 210 931.7
Sep. 22, 2023 (DE) 10 2023 209 269.7

(51) Int. Cl. F16K 11/07; F16K 47/10

(52) U.S. Cl. CPC F16K 11/0712; F16K 47/10; F16K 15/025

(57) ABSTRACT

A valve section for a hydraulic system includes at least a first hydraulic port and a second hydraulic port, a spool, a pressure channel, a collector channel, an inlet pressure compensator disposed between the pressure channel and the spool, and an outlet pressure compensator disposed between the spool and the collector channel. The spool selectively connects the first hydraulic port to the pressure channel and the second hydraulic port to the collector channel or connects the first hydraulic port to the collector channel and the second hydraulic port to the pressure channel. The inlet pressure compensator and the outlet pressure compensator are controllable via a signal pressure device. An external additional force component dependent on an operating state of the hydraulic system acts on the hydraulic port connected to the collector channel on the signal pressure device such that the inlet pressure compensator blocks the pressure channel.

### CROSS REFERENCE TO RELATED APPLICATION

This application claims priority from German Patent Application No. 10 2022 210 931.7, filed on Oct. 17, 2022, and German Patent Application No. 10 2023 209 269.7, filed Sep. 22, 2023, the entire content of both are incorporated herein by reference in their entirety.

### FIELD OF THE INVENTION

The present invention relates to a valve section for a hydraulic system and to a hydraulic system having such a valve section. The hydraulic system is in particular a hydraulic system suitable for a mobile hydraulic system.

### BACKGROUND OF THE INVENTION

Such hydraulic systems are used in a wide variety of mobile hydraulic applications, such as aerial ladders for fire trucks, excavators for earthmoving, municipal vehicles, refuse collection vehicles, forestry cranes, loading cranes, concrete pumps, harvesters, container loading cranes or other grabs. These mobile hydraulic applications have in common that a load is lifted to move it from one place to another. For this purpose, the mobile hydraulic applications have hydraulic consumers that are regularly configured as hydraulic cylinders or hydraulic motors. Differential cylinders in particular are used as hydraulic cylinders.

In order to move a load, various movements are induced via the hydraulic consumers, for example lifting and lowering, tilting, swiveling, rotating, extending or gripping. For this purpose, the hydraulic consumers are pressurized accordingly via the hydraulic system, which is provided via a pump of the hydraulic system and distributed to the hydraulic consumers via the corresponding valve sections. For this purpose, the valve sections have at least a first hydraulic port and a second hydraulic port for supplying the hydraulic consumer with hydraulic fluid. Via a spool, the first hydraulic port can selectively be connected to a pressure channel and the second hydraulic port to a drain, or the first hydraulic port can be connected to the drain and the second hydraulic port to the pressure channel. In other words, one of the hydraulic ports is pressurized, whereas the other hydraulic port is not pressurized.

Generally, such hydraulic systems are also configured as so-called load-sensing systems, in which the highest load pressure present in the system is signaled via a common load pressure channel. In order to control the volume flow to the individual hydraulic consumers, this load pressure is signaled to a pressure compensator of each valve section, whereby the valve section with the highest load pressure specifies the pump pressure to be set. The respective pressure compensator compares the load pressure present in the corresponding valve section with the pressure downstream of the pressure compensator and upstream of the spool or spool edge respectively. A pressure difference between the load pressure of the valve section and the pressure downstream of the pressure compensator and upstream of the spool edge is set via a spring element in the pressure compensator. Due to the always equal pressure difference, the volume flow depends only on a following throttle cross-section of the spool.

This type of hydraulic system configuration has proven itself in a wide variety of mobile hydraulic applications. However, increased energy requirements are to be expected, particularly due to the pressure compensator control. In general, it is therefore desirable in such mobile hydraulic applications that as little energy as possible is consumed or energy is “recycled”. This is particularly desirable if the energy supply for the hydraulic system is not provided by a combustion engine but by a battery. Particularly in the municipal sector and for loading cranes, electrified solutions have recently been increasingly used.

### SUMMARY OF THE INVENTION

It is therefore an object of the present invention to provide a valve section for a hydraulic system which operates in a particularly energy-efficient manner. Furthermore, it is the object of the present invention to provide a corresponding hydraulic system with at least one such valve section, as well as a mobile hydraulic system with a hydraulic system.

The problem is solved with a valve section according to the embodiments disclosed herein. Preferable embodiments are described in the dependent claims.

The valve section for a hydraulic system according to the invention comprises at least a first hydraulic port and a second hydraulic port for supplying hydraulic fluid to at least one hydraulic consumer. Furthermore, the valve section comprises a spool, a pressure channel and a collector channel, wherein the pressure channel is connectable to a pump of the hydraulic system. The spool selectively connects the first hydraulic port to the pressure port and the second hydraulic port to the collector port, or connects the first hydraulic port to the collector port and the second hydraulic port to the pressure port. According to the invention, an inlet pressure compensator is disposed between the pressure channel and the spool, and an outlet pressure compensator is disposed between the spool and the collector channel. The inlet pressure compensator and the outlet pressure compensator can be controlled via a signal pressure device. An external additional force component at the first or second hydraulic port, which is dependent on an operating state of the hydraulic system, acts on the signal pressure device in such a way that the inlet pressure compensator blocks the pressure channel. In other words, the inlet pressure compensator then blocks the connection between the pressure channel and the spool. In particular, the external additional force component acts on the hydraulic port connected to the collector channel.

In other words, if an external additional force component, for example a pulling load, additionally acts in the desired direction of movement of the hydraulic consumer connected to the respective hydraulic port, the resulting additional pressure signal is signaled via the signal pressure device in such a way that the inlet pressure compensator shuts off the connection to the pressure channel and pressure is supplied to the actuated hydraulic port via the collector channel. This saves energy, since no pressure has to be supplied via the pump, but the collector channel takes over a pressure accumulator-like function.

Preferably, the signal pressure device comprises a first signal pressure line, wherein the first signal pressure line is connected to the first hydraulic port when the first hydraulic port is connected to the collector channel via the spool, and wherein the first signal pressure line is connected to the second hydraulic port when the second hydraulic port is connected to the collector channel via the spool.

Preferably, the signal pressure device comprises a second signal pressure line, wherein the second signal pressure line is connected to the first hydraulic port when the second hydraulic port is connected to the collector channel via the spool, and wherein the second signal pressure line is connected to the second hydraulic port when the first hydraulic port is connected to the collector channel.

Preferably, the signal pressure device has a third signal pressure line, the third signal pressure line branching off between the inlet pressure compensator and the spool.

Preferably, the signal pressure device has a fourth signal pressure line, the fourth signal pressure line branching off between the spool and the outlet pressure compensator.

Preferably, the pressure in the first signal pressure line is applied to the outlet pressure compensator on the close-control side.

Preferably, the first signal pressure line and the third signal pressure line are connected to one another via a first shuttle valve, the first shuttle valve being connected to the inlet pressure compensator on the close-control side. Thus, either the pressure applied to the first signal pressure line or the pressure applied to the third signal pressure line is signaled to the inlet pressure compensator via the first shuttle valve on the close-control side, i.e. in the closing direction of the inlet pressure compensator, depending on which of the two pressures is higher.

Preferably, the pressure in the second signal pressure line is applied to the inlet pressure compensator on the open-control side, i.e. in the opening direction.

Preferably, the second signal pressure line and the fourth signal pressure line are connected to one another via a second shuttle valve, wherein the second shuttle valve is connected on the open-control side to the outlet pressure compensator. Consequently, either the pressure applied to the second signal pressure line or the pressure applied to the fourth signal pressure line is signaled to the outlet pressure compensator via the second shuttle valve on the open-control side, i.e. in the opening direction of the outlet pressure compensator, depending on which of the two pressures is higher.

Preferably, the inlet pressure compensator has a first biasing element acting on the open-control side. Preferably, the outlet pressure compensator has a second biasing element acting on the open-control side.

The interconnection logic of the inlet pressure compensator and the outlet pressure compensator described above can be used to ensure that the inlet pressure compensator closes completely and blocks the pressure channel in the event of a possible external and additional force component, while the outlet pressure compensator is open and thus feeds into the collector channel.

It is further preferable if the valve section has a load pressure signal line, wherein the second signal pressure line is connected to the load pressure signal line via a third shuttle valve. The highest load pressure acting globally in the entire hydraulic system is signaled via the load pressure signal line. If the load pressure in the second signal pressure line exceeds the load pressure of any downstream valve sections, this is signaled to the load pressure signal line via the third shuttle valve. The pressure applied to the load pressure signal line is signaled via a corresponding connection block to a supply regulator or directly to a variable displacement pump.

Preferably, the valve section comprises a return channel that can be connected to a tank of the hydraulic system.

Preferably, the valve section has a feed line opening into the collector channel. The outlet pressure compensator is expediently designed as a preferably proportional 3/3-way pressure compensator and is connected on the inlet side to the spool and on the outlet side to the feed line and the return channel. In other words, the volume flow flowing from one of the hydraulic ports via the spool to the outlet pressure compensator can flow at least partially via the outlet pressure compensator into the feed line and thus into the collector channel depending on the pressure signals signaled by the signal pressure device.

Alternatively, it is preferable if the valve section has a feed line which opens between the spool and the inlet pressure compensator. Preferably, the outlet pressure compensator is configured as a preferably proportional 3/3-way pressure compensator and is connected on the inlet side to the spool and on the outlet side to the feed line and the return channel. In other words, the volume flow flowing from one of the hydraulic ports via the spool to the outlet pressure compensator can be at least partially fed back directly downstream to the inlet pressure compensator via the outlet pressure compensator depending on the pressure signals signaled by the signal pressure device, and can thus be “recycled”.

Alternatively, it is preferably if the valve section has a feed line, wherein the outlet pressure compensator is configured as a 2/2-way pressure compensator and is connected on the inlet side to the spool and on the outlet side to the feed line, whereby the feed line opens into the collector channel. In this way, hydraulic fluid flowing out via the outlet pressure compensator can be fed directly back downstream to the inlet pressure compensator via the collector channel and can thus be “recycled”.

In this context, it is preferable if the spool is configured in such a way that the volume flow to the hydraulic consumer as a function of an inlet area of the hydraulic consumer is equal to or greater than the volume flow away from the hydraulic consumer as a function of an outlet area of the hydraulic consumer. Particularly preferably, the volume flow to the hydraulic consumer is greater than the volume flow away from the hydraulic consumer. If the hydraulic consumer is a double-acting cylinder, for example, the inlet area is either the piston-side or the rod-side cylinder surface and the outlet area is consequently the other of these two surfaces. This enables particularly stable control of the hydraulic consumer, especially if the outlet pressure compensator is configured as a 3/3-way pressure compensator.

Preferably, a feed line check valve opening in the direction of flow away from the outlet pressure compensator is disposed in the feed line. In this way, a backflow to the outlet pressure compensator can be reliably prevented.

Preferably, the collector channel is the return channel, with the valve section having a suction arrangement. Preferably, the return channel is then preloaded to allow for sufficient pressure storage. Preferably, the suction arrangement connects the return channel to the first hydraulic port and the second hydraulic port.

Alternatively, it may be preferable for the valve section to comprise a suction arrangement, wherein the suction arrangement connects the collector channel to the first hydraulic port and the second hydraulic port.

Here, it is preferable if the suction arrangement has a first suction line with a first suction valve and a second suction line with a second suction valve, wherein the first suction line opens between the spool and the first hydraulic port and wherein the second suction line opens between the spool and the second hydraulic port.

Alternatively, it is preferable if the valve section has a suction arrangement, the suction arrangement having a third suction line with a third suction valve, the third suction line branching off between the inlet pressure compensator and the spool and opening into the collector channel.

Preferably, the suction arrangement has a first protection line with a first pressure relief valve, the first protection line branching off between the spool and the first hydraulic port and opening into the return channel. Accordingly, it is preferable if the suction arrangement has a second protection line with a second pressure relief valve, the second protection line branching off between the spool and the second hydraulic port and opening into the return channel.

Preferably, the valve section has a bypass line, the bypass line connecting the first hydraulic port and/or the second hydraulic port to the collector channel via the spool and bypassing the outlet pressure compensator. In particular, the bypass line connects the corresponding hydraulic port directly to the return channel, bypassing the outlet pressure compensator. In other words, depending on the switch position of the spool, one of the two hydraulic ports can be connected directly to the return channel via the bypass line, so that hydraulic fluid that is drained and not suitable for recycling can be discharged directly to the tank. This further saves energy as there is no discharge via the outlet pressure compensator.

Preferably, a first pilot-operated check valve that opens in the direction of flow to the spool is disposed between the spool and the first hydraulic port and a second pilot-operated check valve that opens in the direction of flow to the spool is disposed between the spool and the second hydraulic port. A pressure applied to the second hydraulic port unlocks the first check valve and a pressure applied to the first hydraulic port unlocks the second check valve. The check valves replace load holding valves that would otherwise have to be provided, which is more favorable overall in terms of energy, since when a load is lowered only a standby pressure of the pump is required to unlock the corresponding check valve.

Furthermore, the problem is solved with a hydraulic system according to claim 26. Preferable embodiments are described in the dependent claims.

The hydraulic system according to the invention comprises at least one valve section according to the invention described above, as well as a pump and a tank. The pressure channel of the valve section is connected to the pump and the return channel is connected to the tank. Of course, it is possible that the hydraulic system comprises two or more valve sections according to the invention, whereby the valve sections need not be identical in construction. For example, it may be preferable that the outlet pressure compensator of one valve section is connected to the return channel, whereas the outlet pressure compensator of another valve section is connected to the collector channel.

Here, it is preferable if the hydraulic system comprises an intermediate section, the intermediate section having a preloading valve, the preloading valve preloading the collector channel, which is configured as a return channel, to a predetermined pressure.

Alternatively, it may be preferable if the hydraulic system comprises an intermediate section, the intermediate section comprising a filling line with a filling valve, the filling line connecting the pressure channel with the collector channel. In this regard, it is preferable if the intermediate section comprises a drain line with a drain valve, the drain line connecting the collector channel to the return channel. For example, the filling valve can be set to 10 bar and the downstream suction valve to 9 bar. It can thus be ensured that the collector channel is always preloaded with a desired pressure.

The intermediate section can be configured as an independent section, as part of a connection block or also as part of a valve section. Several intermediate sections can also be provided.

Furthermore, it is preferable if the hydraulic system has a first connecting line for connecting the at least one hydraulic consumer to the first pressure port and a second connecting line for connecting the at least one hydraulic consumer to the second pressure port. A first flow control valve, which is preferably configured as a lowering brake valve, or a first line-break protection device is disposed in the first connecting line, and a second flow control valve, which is preferably configured as a second lowering brake valve, or a second line-break protection device is disposed in the second connecting line. This is particularly preferable if the load-holding valves that are actually to be provided are replaced by pilot-operated check valves. In addition, this increases safety and prevents uncontrolled lowering of a raised load.

With the valve section according to the invention or with the hydraulic system according to the invention, energy can be saved on the one hand by blocking the pressure channel in the event of an external additional force component. Furthermore, the collector channel can be used to provide a channel that is preloaded to a desired pressure, i.e. is configured in the manner of an accumulator, via which outflowing hydraulic fluid is recirculated.

Of course, in the sense of the invention, the blocking of the pressure channel can also be used independently of the recirculation of the hydraulic fluid via the collector channel. Accordingly, the collector channel can also be implemented without blocking the pressure channel. Furthermore, the various valve sections described above can be combined in any number and manner as required and to suit the desired function.

The problem is ultimately also solved with a mobile hydraulic system according to the invention having a hydraulic system as described above.

### BRIEF DESCRIPTION OF THE DRAWINGS

FIG. 1 is a hydraulic circuit diagram of a mobile hydraulic system with a hydraulic system according to the invention according to a first embodiment;

FIG. 2 is a hydraulic circuit diagram of a mobile hydraulic system with a hydraulic system according to the invention according to a second embodiment;

FIG. 3 is a hydraulic circuit diagram of a mobile hydraulic system with a hydraulic system according to the invention according to a third embodiment;

FIG. 4 is a hydraulic circuit diagram of a mobile hydraulic system with a hydraulic system according to the invention according to a fourth embodiment;

FIG. 5 is a hydraulic circuit diagram of a mobile hydraulic system with a hydraulic system according to the invention according to a fifth embodiment; and

FIG. 6 is a hydraulic circuit diagram of a mobile hydraulic system with a hydraulic system according to the invention according to a sixth embodiment.

### DETAILED DESCRIPTION OF THE INVENTION

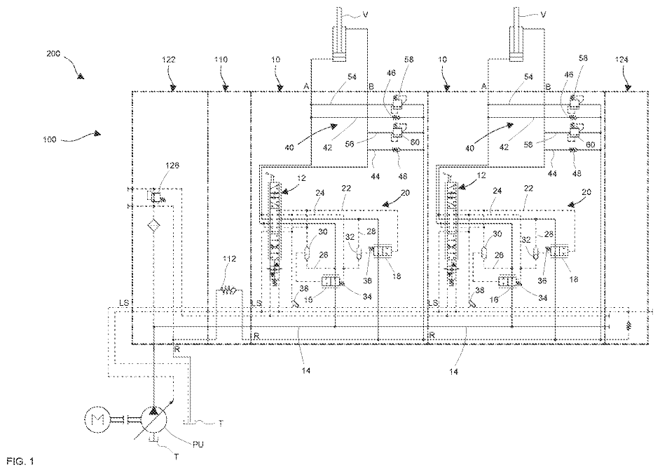

FIG. 1 depicts a hydraulic circuit diagram of a mobile hydraulic system 200 with a hydraulic system 100 according to the invention in accordance with a first embodiment. In this exemplary embodiment, the hydraulic system 100 has two valve sections 10. The hydraulic system 100 is of sandwich construction and further comprises an intermediate section 110, a connection block 122, and an end plate 124. In this embodiment, the connection block 122 includes a pressure reducing valve 126. The pressure reducing valve 126 reduces the pilot pressure for the individual valve sections 10 in a known manner. Furthermore, the connection block 122 and the end plate 124 are formed in a conventional manner, so that no further description is required.

The hydraulic system 100 further comprises a pump PU driven by a motor M. In addition, the hydraulic system 100 has a tank T from which the pump PU draws the hydraulic fluid and supplies it to the connection block 122. In this exemplary embodiment, the pump PU is configured as a variable displacement pump. The valve sections 10 in this exemplary embodiment are identically constructed, so that only one of the two valve sections 10 is described below.

The valve section 10 has a first hydraulic port A and a second hydraulic port B for supplying hydraulic fluid to at least one hydraulic consumer V of the mobile hydraulic system 200. In this embodiment, the hydraulic consumer V is a differential cylinder.

Further, the valve section 10 includes a spool 12 and a pressure channel 14 that is connected in a conventional manner to the connection block 122 via the intermediate section 110. An inlet pressure compensator 16 controls the supply of hydraulic fluid from the pressure channel 14 to the spool 12, as will be described in further detail below. In this embodiment, the inlet pressure compensator 16 is a proportional 2/2-way pressure compensator. Furthermore, the valve section 10 has a collector channel formed as a return channel R. The spool 12 is connected to the return channel R via an outlet pressure compensator 18. In this embodiment, the outlet pressure compensator 18 is configured as a proportional 2/2-way pressure compensator. The spool 12 can be proportionally moved from a neutral position shown in FIG. 1 to a first or second switching position. In the first switching position, the spool 12 connects the pressure channel 14 to the first hydraulic port A and the second hydraulic port B to the return channel R. Correspondingly, in the second switching position, the spool 12 connects the pressure channel 14 to the second hydraulic port B and the first hydraulic port A to the return channel R. The inflow or outflow of the hydraulic ports A, B is controlled via the inlet pressure compensator 16 and the outlet pressure compensator 18.

Therefore, the valve section 10 comprises a signal pressure device 20. The signal pressure device 20 comprises a first signal pressure line 22 which is connected to the first hydraulic port A when the spool 12 is in the second switching position, i.e. when the first hydraulic port A is connected to the return channel R via the spool 12. Accordingly, the first signal pressure line 22 is connected to the second hydraulic port B when the spool 12 is in the first switching position, that is, when the second hydraulic port B is connected to the return channel R via the spool 12. The signal pressure device 20 further comprises a second signal pressure line 24 connected to the first hydraulic port A when the spool 12 is in the first switching position, that is, when the second hydraulic port B is connected to the return channel R. Accordingly, the second signal pressure line 24 is connected to the second hydraulic port B when the spool 12 is in the second switching position, that is, when the first hydraulic port A is connected to the return channel R. The signal pressure device 20 comprises a third signal pressure line 26 that branches off between the inlet pressure compensator 16 and the spool 12. In addition, the signal pressure device 20 has a fourth signal pressure line 28 that branches off between the spool 12 and the outlet pressure compensator 18.

The pressure in the first signal pressure line 22 is signaled to the outlet pressure compensator 18 on the close-control side. Furthermore, the first signal pressure line 22 is connected to the third signal pressure line 26 via a first shuttle valve 30. The corresponding higher pressure is signaled to the inlet pressure compensator 16 on the close-control side via the first shuttle valve 30. The pressure in the second signal pressure line 24 is signaled on the open-control side to the inlet pressure compensator 16 and acts together with a first biasing element 34 in the open-control direction of the inlet pressure compensator 16. The second signal pressure line 24 is also connected to the fourth signal pressure line 28 via a second shuttle valve 32. The correspondingly higher pressure is signaled on the open-control side to the outlet pressure compensator 18 via the second shuttle valve 32 and acts together with a second biasing element 36 in the open-control direction of the outlet pressure compensator 18.

Further, the second signal pressure line 22 is connected to a load pressure signal line LS of the valve section 10 via a third shuttle valve 38. Via the third shuttle valve 38, the highest load pressure of the hydraulic system 100 is signaled for pump control in a conventional manner.

In addition, the valve section 10 comprises a suction arrangement 40. The suction arrangement 40 has a first suction line 42 and a second suction line 44. A first suction valve 46 is disposed in the first suction line 42, which in this exemplary embodiment is configured as a spring-loaded check valve. Correspondingly, a second suction valve 48 is disposed in the second suction line 44, which in this exemplary embodiment is also configured as a spring-loaded check valve. The first suction line 42 connects the return flow channel R to the first hydraulic port A and opens downstream of the spool 12, as seen in the direction of flow to the first hydraulic port A. The second suction line 44 connects the return flow channel R to the second hydraulic port B and opens downstream of the spool 12 as seen in the direction of flow to the second hydraulic port B.

The suction arrangement 40 further comprises a first protection line 54 and a second protection line 56. A first pressure relief valve 58 is disposed in the first protection line 54. A second pressure relief valve 60 is disposed in the second protection line 56. The first protection line 54 branches off downstream of the spool 12 as seen in the direction of flow to the first hydraulic port A and opens into the return flow channel R. Correspondingly, the second protection line 56 branches off downstream of the spool 12 as seen in the direction of flow to the second hydraulic port B and also opens into the return flow channel R. Thus, damage to the hydraulic system 100 can be prevented via the first or second pressure relief valve 58, 60.

The return channel R of the valve section 10 is connected to the tank T via the intermediate section 110. A preloading valve 112 in the form of a spring-loaded check valve is provided in the intermediate section 110. Via the preloading valve 112, the pressure in the return channel R between the intermediate section 110 and the end plate 124 can be preloaded to a predetermined pressure level or pressure, for example to 10 bar or even 20 bar.

Next, the function of the hydraulic system 100 according to the invention will be described.

During a conventional movement, for example for lifting a load, the inlet pressure compensator 16 and the outlet pressure compensator 18 are controlled via the signal pressure device 20 so that both the inlet pressure compensator 16 and the outlet pressure compensator 18 are open. For example, when a pulling load acts as an external additional force component on the hydraulic consumer V when the first hydraulic port A is pressurized, the signal pressure device 20 controls the inlet pressure compensator 16 to close. In other words, with the hydraulic consumer V configured as a differential cylinder in this exemplary embodiment, an external force additionally acts in the extension direction of the piston. This can be the case, for example, when lowering a lifted load.

In this case, the signal pressure in the first signal pressure line 22 exceeds the pressure in the third signal pressure line 26 as well as the pressure acting on the open-control side on the inlet pressure compensator 16, i.e. the pressure generated by the first biasing element 34 as well as the pressure in the second signal pressure line 24 also acting in the open-control direction of the inlet pressure compensator 16. In this case, since the pressure in the fourth signal pressure line 28 exceeds the pressure in the second signal pressure line 24, the second shuttle valve 32 closes, so that the pressure signaled on the open-control side to the outlet pressure compensator 18, together with the force generated by the second biasing element 36, is higher than the pressure in the first signal pressure line 22. Consequently, the inlet pressure compensator 16 is closed and the outlet pressure compensator 18 is open. Any differential volume of hydraulic fluid is sucked directly out of the preloaded return channel R via the suction arrangement 40.

Consequently, the hydraulic fluid draining off via the second hydraulic port B is not fed directly into the tank T via the return flow channel R and sucked in again via the pump PU, but is “recycled” directly. Only when the pressure in the return channel R exceeds the pressure set at the preloading valve 112 the return channel R opens towards the tank T.

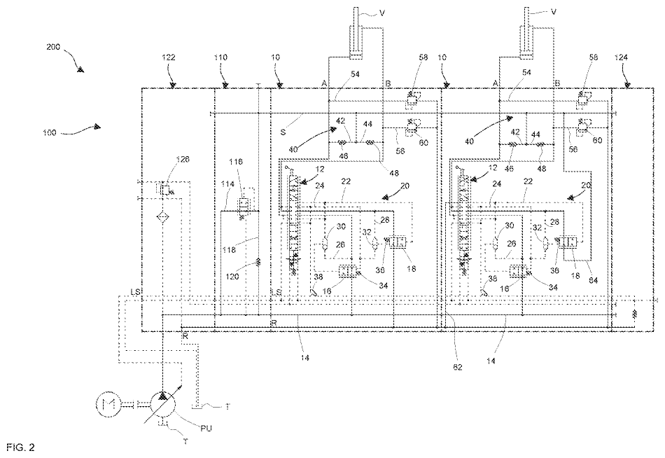

In FIG. 2, a hydraulic circuit diagram of a mobile hydraulic system 200 with a hydraulic system 100 according to the invention is shown according to a second embodiment.

The hydraulic system 100 according to the second embodiment differs from the hydraulic system 100 according to the first embodiment shown in FIG. 1, among other things, in that a separate collector channel S is provided in addition to the return channel R. In the valve section 10 directly adjacent to the intermediate section 110 in FIG. 2, the outlet pressure compensator 18 is connected to the return channel R as in the first embodiment. In the other valve section 10, the outlet pressure compensator 18 is connected to the collector channel S and not to the return channel R. The suction arrangement 40 of both valve sections 10 is configured such that hydraulic fluid is directly sucked from the collector channel S by connecting the first suction line 42 and the second suction line 44 to the collector channel S, respectively.

Furthermore, the hydraulic system 100 according to the second embodiment differs from the embodiment shown in FIG. 1 in that a bypass line 62 is provided in a valve section 10 (the valve section 10 shown on the left in FIG. 2), which connects the spool 12 directly to the return channel R, bypassing the outlet pressure compensator 18. In this case, the spool 12 is configured in such a way that in the first switching position, i.e. when the first hydraulic port A is connected to the pressure channel 14 or the inlet pressure compensator 16 respectively, it connects the second hydraulic port B directly to the return channel R via the bypass line 62. In this way, when the hydraulic consumer V is pressurized via the first hydraulic port A, for example to lift a load, the hydraulic fluid flowing out via the hydraulic port B can be relieved directly via the return flow channel R.

Furthermore, the hydraulic system 100 according to the second embodiment differs from the embodiment shown in FIG. 1 in that in the valve section 10 shown on the right in FIG. 2, the connection of the outlet pressure compensator 18 is configured differently. The outlet pressure compensator 18 is not directly connected to the return channel R, but is connected to the collector channel S via a feed line 64. Thus, when the second hydraulic port B is pressurized, the first hydraulic port A is directly connected to the collector channel S via the outlet pressure compensator 18 in order to directly feed the hydraulic fluid, which flows back and is pressurized, for example, when lowering a load applied to the hydraulic consumer V, to the collector channel S and thus to “recycle” it as described above with reference to FIG. 1. In combination with the bypass line 62, this makes it possible to direct the backflowing hydraulic fluid into the collector channel S only when the hydraulic consumer V is retracted or only when the hydraulic consumer V is extended.

Further, the intermediate section 110 differs from the intermediate section shown in the first embodiment. Specifically, the intermediate section 110 of the hydraulic system 100 according to the second embodiment comprises a filling line 114 having a filling valve 116 disposed therein. Further, the intermediate section 110 comprises a drain line 118 having a drain valve 120 disposed therein. In this embodiment, the drain valve 120 is configured as a spring-loaded check valve. The filling line 114 is connected on the one hand to the collector channel S and on the other hand to the pressure channel 14 or the pump PU respectively. The drain line 118 connects the collector channel S to the return channel R. Here, the filling valve 116 and the drain valve 120 are matched to each other in such a way that a desired preload is always present in the collector channel S. For example, the filling valve 116 can be set so that it ensures a minimum pressure of 9 bar in the collector channel S. The drain valve 120 is then set so that it opens at a pressure of 10 bar, for example.

According to the second exemplary embodiment, it is therefore possible that the returning hydraulic fluid is recycled into the collector channel S only at those valve sections 10 where an external additional force component is also to be expected. This may be the case, for example, with the valve section 10 through which the load is raised and lowered. In contrast, in the case of a valve section 10 that is responsible for rotation, for example, an additional external force component is not to be expected, so that the outlet pressure compensator 18 of this valve section 10 can be connected directly to the return channel R.

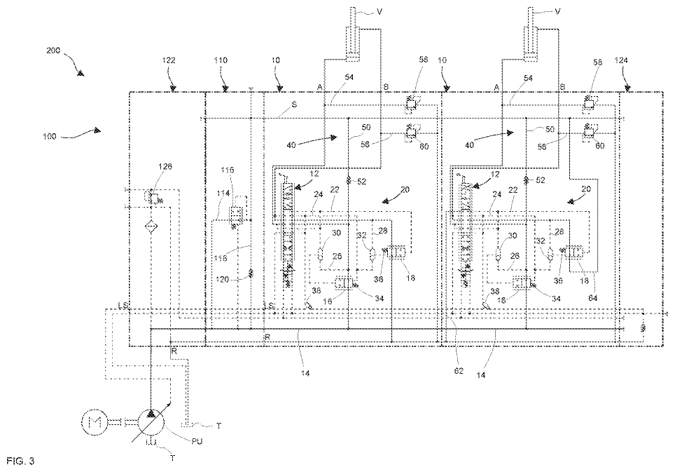

A third embodiment of a mobile hydraulic system 200 with a hydraulic system 100 according to the invention is shown in FIG. 3. The hydraulic system 100 according to the third embodiment differs from the exemplary embodiment shown in FIG. 2 in the configuration of the suction arrangement 40.

In this exemplary embodiment, the suction arrangement 40 has a third suction line 50 and a third suction valve 52 disposed in the third suction line 50. In this exemplary embodiment, the third suction valve 52 is configured as a spring-loaded check valve. The third suction line 50 branches off downstream of the inlet pressure compensator 16 and upstream of the spool 12 and opens into the collector channel S. If an additional external force component acts on the hydraulic consumer V, for example a pulling load, the inlet pressure compensator 16 is closed as described above so that the pressure channel 14 is blocked. In this case, the hydraulic fluid is sucked directly from the collector channel S via the third suction line 50 and directed to the actuated hydraulic port A, B via the spool 12. Both in the hydraulic system 100 according to the second embodiment and in the hydraulic system 100 according to the third embodiment, the filling valve 116 disposed in the intermediate section 110 ensures that a sufficient amount of hydraulic fluid with the appropriate preload is kept available in the collector channel S. Nevertheless, filling of the collector channel S via the filling valve 116 only takes place when the preload in the collector channel S falls below the value set at the filling valve 116.

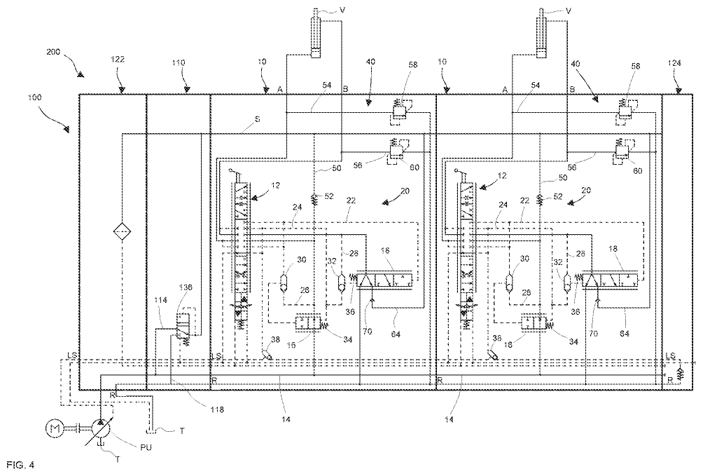

FIG. 4 shows a hydraulic circuit diagram of a mobile hydraulic system 200 according to a fourth embodiment.

In this embodiment, two identical valve sections 10 are shown as an example, which differ from the valve section shown on the right in FIG. 3 by the configuration and connection of the outlet pressure compensator 18. In this exemplary embodiment, the outlet pressure compensator 18 is configured as a proportional 3/3-way pressure compensator and is connected to the spool 12 on the input side. On the output side, the outlet pressure compensator 18 is connected on the one hand to the return channel R and on the other hand to the collector channel S via the feed line 64. Depending on the pressure signals applied to the outlet pressure compensator 18 and signaled via the signal pressure device 20, as well as the bias of the second biasing element 36, the outlet pressure compensator 18 connects the spool 12 to the return channel R and the feed line 64 in a first switching position, to the feed line only in a second switching position, and completely blocks the connection in a third switching position. Depending on the pressure signals signaled via the signal pressure device 20, the hydraulic fluid flowing back via the spool 12 can be at least partially relieved directly towards the tank T via the return flow channel R or completely supplied to the collector channel S. Compared to the configuration shown in FIG. 2, no bypass is thus necessary.

As shown, a feed line check valve 70 is disposed in the feed line 64 to prevent backflow from the collector channel S through the outlet pressure compensator 18.

Furthermore, the intermediate section 110 is configured differently in this exemplary embodiment. Instead of a filling valve 116 and a drain valve 120, a collection valve 136 configured as a 3/2-way valve is provided in this embodiment. When the pressure in the collector channel S rises above a set level, the collection valve 136 relieves the collector channel S via the return channel R to the tank T.

Thus, a constant pilot pressure in the collector channel S, for example of 20 bar, can be achieved via the third suction valve 52 and the collection valve 136. As a result, the pressure reducing valve 126 in the connection block 122 can also be omitted in this exemplary embodiment, because the pilot pressure signal for the valve sections 10 is signaled directly via the collector channel S.

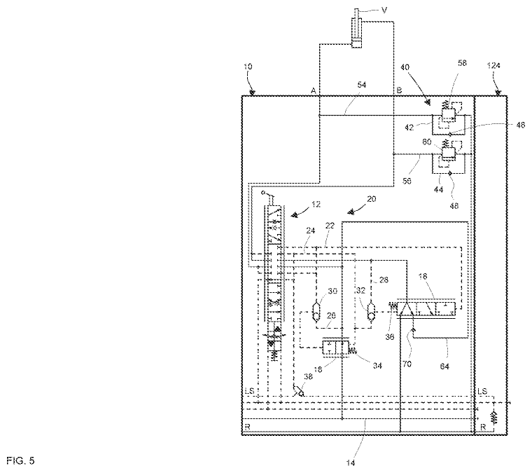

FIG. 5 shows a hydraulic circuit diagram of a mobile hydraulic system according to a fifth embodiment. For the sake of simplicity, only a valve section 10 and the hydraulic consumer are shown here.

The embodiment shown in FIG. 5 differs from the embodiment shown in FIG. 4 in that the feed line 64 opens directly between the inlet pressure compensator 16 and the spool 12. A separate collector channel S is not provided. When the hydraulic consumer V, which is configured as a cylinder, is retracted, the hydraulic fluid flowing back via the first hydraulic port A is at least partially introduced directly via the feed line 64 downstream of the inlet pressure compensator 16 and supplied to the hydraulic consumer V via the second hydraulic port B. The hydraulic consumer V is then supplied with hydraulic fluid via the second hydraulic port B.

When the hydraulic consumer V configured as a cylinder is extended, the pressure applied via the inlet pressure compensator 16 blocks the feed line check valve 70 so that the outflowing hydraulic fluid is relieved directly via the outlet pressure compensator 18 to the return channel R. Alternatively, however, it is also conceivable that a pressure intensification is provided so that the returning hydraulic fluid is fed back via the feed line 64 directly downstream of the inlet pressure compensator 16.

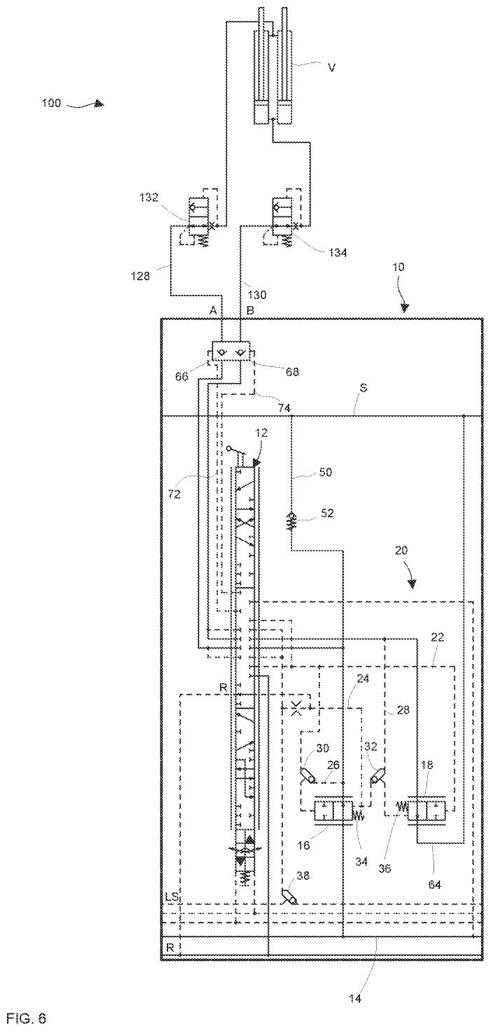

FIG. 6 shows a hydraulic circuit diagram of a mobile hydraulic system according to a sixth embodiment. For the sake of simplicity, only a valve section 10 and the hydraulic consumer are shown here.

The valve section 10 according to this sixth embodiment differs from the embodiment shown in FIG. 4 on the one hand in that no protection lines 54, 56 and consequently also no corresponding pressure relief valves 58, 60 are provided. However, an embodiment with protection lines and pressure relief valves is of course also conceivable. On the other hand, a first check valve 66 is disposed between the spool 12 and the first hydraulic port A. As shown, the first check valve 66 blocks in the direction of flow from the first hydraulic port A to the spool 12. Furthermore, the first check valve 66 can be opened by means of a pressure applied to the second hydraulic port B. Accordingly, a second check valve 68 is disposed between the spool 12 and the second hydraulic port B, which blocks in the direction of flow from the second hydraulic port B to the spool 12. The second check valve 68 can be opened by means of a pressure applied to the first hydraulic port A.

As shown, the first check valve 66 is unlocked via a first control line 72, which is connected to the pressure channel 14 via the spool 12 when the spool 12 is in a switching position for pressurization of the second hydraulic port B (the upper switching position of the spool 12 in FIG. 6). Accordingly, the second check valve 68 is unblocked via a second control line 74, which is connected to the pressure channel 14 via the spool 12 when the spool 12 is in a switching position for pressurizing the first hydraulic port A (the lower switching position of the spool 12 in FIG. 6).

In this embodiment, the hydraulic consumer V is configured as a double cylinder and is connected to the first hydraulic port A via a first connecting line 128 and to the second hydraulic port B via a second connecting line 130. A first flow control valve 132 is disposed in the first connecting line 128 and a second flow control valve 134 is disposed in the second connecting line 130. In this embodiment, the first flow control valve 132 and the second flow control valve 134 are configured as 2-way flow control valves, which are also known as lowering brake valves.

The combination of hydraulically pilot-operated check valves 66, 68 and lowering brake valves 132, 134 eliminates the need for separate load holding valves that would normally be provided in such a hydraulic layout. This is advantageous overall in terms of energy, since only the standby pressure of the pump PU is required to lower the load, since no pilot pressure needs to be generated via the pump PU to open a load-holding valve. Only the corresponding check valve 66, 68 must be opened via the then only low pressure.

Line break protection devices can also be used instead of the flow control valves 132, 134.

It should be noted that the numerical terms used herein, such as “first,” “second,” “third,” or “fourth,” do not impose a mandatory order, but are used solely to distinguish the features or elements.

In addition, it should also be noted that a hydraulic system according to the invention can have a large number of different valve sections described above, which can also be configured differently depending on requirements. For example, the valve section shown on the left in FIG. 2 can also be used in combination with a valve section shown in FIG. 4. Furthermore, it is also conceivable that the outlet pressure compensator 18 shown in FIG. 6 is configured as a 3/3-way pressure compensator as shown in FIG. 4 or FIG. 5.

### LIST OF REFERENCE SIGNS

10 valve section
12 spool
14 pressure channel
16 inlet pressure compensator
18 outlet pressure compensator
20 Signal pressure device
22 first signal pressure line
24 second signal pressure line
26 third signal pressure line
28 fourth signal pressure line
30 first shuttle valve
32 second shuttle valve
34 first biasing element
36 second preload element
38 third shuttle valve
40 Suction arrangement
42 first suction line
44 second suction line
46 first suction valve
48 second suction valve
50 third suction line
52 third suction valve
54 first protection line
56 second protection line
58 first pressure relief valve
60 second pressure relief valve
62 bypass line
64 feed line
66 first check valve
68 second check valve
70 feed line check valve
72 first control line
74 second control line
100 hydraulic system
110 intermediate section
112 preloading valve
114 filling line
116 filling valve
118 drain line
120 drain valve
122 connection block
124 end plate
126 pressure reducing valve
128 first connecting line
130 second connecting line
132 first flow control valve
134 second flow control valve
136 collection valve
200 mobile hydraulic system
A first hydraulic port
B second hydraulic port
LS Load pressure signal line
M motor
R return channel
PU pump
S collector channel
T tank
V hydraulic consumer

1. A valve section for a hydraulic system, the valve section comprising:
at least a first hydraulic port and a second hydraulic port for supplying hydraulic fluid to at least one hydraulic consumer;
a spool;
a pressure channel;
a collector channel;
an inlet pressure compensator disposed between the pressure channel and the spool; and
an outlet pressure compensator disposed between the spool and the collector channel,
wherein the pressure channel is connectable to a pump of the hydraulic system,
wherein the spool selectively connects the first hydraulic port to the pressure channel and the second hydraulic port to the collector channel or connects the first hydraulic port to the collector channel and the second hydraulic port to the pressure channel,
wherein the inlet pressure compensator and the outlet pressure compensator are controllable via a signal pressure device, and
wherein an external additional force component dependent on an operating condition of the hydraulic system acts on the signal pressure device at the first hydraulic port or at the second hydraulic port such that the inlet pressure compensator blocks the pressure channel.

2. A valve section according to claim 1, wherein the signal pressure device comprises a first signal pressure line, wherein the first signal pressure line is connected to the first hydraulic port when the first hydraulic port is connected to the collector channel via the spool, and wherein the first signal pressure line is connected to the second hydraulic port when the second hydraulic port is connected to the collector channel via the spool, and the signal pressure device comprises a second signal pressure line, wherein the second signal pressure line is connected to the first hydraulic port when the second hydraulic port is connected to the collector channel via the spool, and wherein the second signal pressure line is connected to the second hydraulic port when the first hydraulic port is connected to the collector channel via the spool, and the signal pressure device has a third signal pressure line, the third signal pressure line branching off between the inlet pressure compensator the spool, and the signal pressure device has a fourth signal pressure line, the fourth signal pressure line branching off between the spool and the outlet pressure compensator.

3. A valve section according to claim 2, wherein the pressure in the first signal pressure line is applied to the outlet pressure compensator on the close-control side.

4. A valve section according to claim 2, wherein the first signal pressure line and the third signal pressure line are connected to one another via a first shuttle valve, the first shuttle valve being connected on the close-control side to the inlet pressure compensator.

5. A valve section according to claim 2, wherein the pressure in the second signal pressure line is applied to the inlet pressure compensator on the open-control side.

6. A valve section according to claim 2, wherein the second signal pressure line and the fourth signal pressure line are connected to one another via a second shuttle valve, the second shuttle valve being connected on the open-control side to the outlet pressure compensator.

7. A valve section according to claim 1, wherein the inlet pressure compensator has a first biasing element acting on the open-control side, and/or the outlet pressure compensator has a second biasing element acting on the open-control side.

8. A valve section according to claim 2, further comprising a load pressure signal line, wherein the second signal pressure line is connected to the load pressure signal line via a third shuttle valve.

9. A valve section according to claim 1, further comprising a return channel connectable to a tank of the hydraulic system.

10. A valve section according to claim 9, further comprising a feed line, wherein the outlet pressure compensator is configured as a 3/3-way pressure compensator and is connected on the inlet side to the spool and on the outlet side to the feed line and the return channel, the feed line opening into the collector channel.

11. A valve section according to claim 1, further comprising a feed line, wherein the outlet pressure compensator is configured as a 3/3-way pressure compensator and is connected on the inlet side to the spool and on the outlet side to the feed line and the return channel, the feed line opening between the spool and the inlet pressure compensator.

12. A valve section according to claim 10, wherein the signal pressure device controls the outlet pressure compensator in such a way that the outlet pressure compensator is connected to the return channel and the feed line in a first switching position, and is connected only to the feed line in a second switching position, and blocks the connection to the feed line and to the return channel in a third switching position.

13. A valve section according to claim 12, further comprising a feed line, wherein the outlet pressure compensator is configured as a 2/2-way pressure compensator and is connected on the inlet side to the spool and on the outlet side to the feed line, the feed line opening into the collector channel.

14. A valve section according to claim 1, wherein the collector channel is a return channel connectable to the tank of the hydraulic system, wherein the valve section further comprises a suction arrangement, the suction arrangement connecting the return channel to the first hydraulic port and the second hydraulic port.

15. A valve section according to claim 9, further comprising a suction arrangement, the suction arrangement connecting the collector channel to the first hydraulic port and the second hydraulic port.

16. A valve section according to claim 14, wherein the suction arrangement comprises a first suction line with a first suction valve and a second suction line with a second suction valve, wherein the first suction line opens between the spool and the first hydraulic port and wherein the second suction line opens between the spool and the second hydraulic port.

17. A valve section according to claim 9, further comprising a suction arrangement, the suction arrangement having a third suction line with a third suction valve, the third suction line branching off between the inlet pressure compensator and the spool and opening into the collector channel.

18. A valve section according to claim 1, further comprising a bypass line, the bypass line connecting the first hydraulic port and/or the second hydraulic port to the collector channel, in particular to the return channel, via the spool and bypassing the outlet pressure compensator.

19. A valve section according to claim 1, further comprising a first pilot-operated check valve opening in the direction of flow to the spool is disposed between the spool and the first hydraulic port, and a second pilot-operated check valve opening in the direction of flow to the spool is disposed between the spool and the second hydraulic port,
wherein a pressure applied to the second hydraulic port unlocks the first check valve and a pressure applied to the first hydraulic port unlocks the second check valve.

20. A hydraulic system comprising at least one valve section according to claim 1, a pump and a tank, wherein the pressure channel is connected to the pump, and wherein the return channel is connected to the tank.

21. A hydraulic system according to claim 20, wherein the hydraulic system comprises an intermediate section, the intermediate section comprising a preloading valve, wherein the preloading valve preloads the collector channel formed as a return channel to a predetermined pressure.

22. A hydraulic system according to claim 20, further comprising an intermediate section, the intermediate section comprising a filling line with a filling valve, the filling line connecting the pressure channel to the collector channel, wherein the intermediate section comprises a drain line with a drain valve, the drain line connecting the collector channel to the return channel.

23. A hydraulic system according to claim 20, further comprising a first connecting line for connecting the at least one hydraulic consumer to the first pressure port and a second connecting line for connecting the at least one hydraulic consumer to the second pressure port, wherein a first flow control valve or a first line break protection device is disposed in the first connecting line and wherein a second flow control valve or a second line break protection device is disposed in the second connection line, wherein the first flow control valve is preferably a first lowering brake valve, and wherein the second flow control valve is preferably a second lowering brake valve.
